(19) United States
(12) Patent Application Publication
(10) Pub. No.: US 2026/0016601 A1
(43) Pub. Date: Jan. 15, 2026

(54) SYSTEM AND METHOD FOR CONSTRUCTING A MAP OF AN ENVIRONMENT

(71) Applicant: OFFROAD, Alfortville (FR)

(72) Inventor: Axel Jean, Michel BARRAU, Boulogne-Billancourt (FR)

(21) Appl. No.: 19/114,402

(22) PCT Filed: Oct. 25, 2023
(86) PCT No.: PCT/EP2023/079853

§ 371 Date: Mar. 21, 2025

(30) Foreign Application Priority Data
Oct. 26, 2022 (FR) FR2211164

(51) Int. Cl. G01S 17/89

(52) U.S. Cl. CPC G01S 17/89

(57) ABSTRACT

A system for constructing a map of an environment comprises a measuring device comprising at least one lidar acquiring a point cloud representative of said environment, a processor configured to pre-select a plurality of initial point sets from the point cloud, each initial point set being representative of a potential area of interest in the environment, or each initial point set, investigate a local correction to be made to a movement of the measuring device along each potential area of interest to determine whether each initial point set actually represents an area of interest, correct together the initial sets of points actually representing an area of interest, by applying a global correction to a movement of the measuring device in the environment, build the map of the environment with the corrected initial point sets and the initial point sets not representing an area of interest.

### FIELD OF INVENTION

The present invention relates to a system and method for constructing a map of an environment. More specifically, the invention relates to the field of automatic mapping of an environment from a three-dimensional point cloud acquired by a mapping device comprising a lidar (Light Detection And Ranging).

### TECHNOLOGICAL BACKGROUND

In the field of automatic mapping, an environment can be mapped by means of a measuring device, mobile in the environment, comprising at least one lidar. The lidar scans the environment in which the device is moving, acquiring point clouds representative of the environment in which it is moving. Such an environment can be a building, a road, a construction site, etc. The map of the environment is built up as the lidar acquires points, i.e. as the measuring device comprising the lidar moves.

However, in some cases, the environment map thus constructed may not be representative of the environment, at least in some places. In this case, the environment map will appear blurred. This can happen because the lidar takes relative measurements, so it is necessary to know its position and orientation to be able to locate the points it returns at each acquisition in a global orthogonal coordinate frame locating the mapped environment.

When lidar measurements are used to jointly calculate the position and orientation of the device and the map, the technique used is called SLAM (Simultaneous Localization and Mapping). It involves the construction of a map of the environment by a measuring device comprising a lidar, combined with the identification of the trajectory and orientation of the measuring device.

In particular, the trajectory of the measuring device is not known at all times. Thus, each hypothetical trajectory of the measuring device may be associated with a different map of the environment. The quality of the map of the environment depends in particular on knowledge of the trajectory of the measuring device, i.e. the correct trajectory of the measuring device in the environment must be found in order to obtain a good quality map of the environment. Consequently, the trajectory of the device can be identified by looking for the one that leads to the best quality environmental map.

The search for the best trajectory and map is carried out simultaneously.

This can be achieved by defining zones of interest in the environment. In particular, such zones may include a flat area of the environment, such as a wall, a facade, a road, etc. Such zones of interest have the advantage of being easily mappable, so that they are of interest in estimating the trajectory of the measuring device in the environment. The aim is to focus on such areas to improve trajectory estimation and obtain a good-quality map

One of the challenges of SLAM is that mapping tends to be done automatically, without an outsider defining which areas are of interest for estimating the trajectory of the measuring device.

With this in mind, the prior art proposes to identify approximately flat zones, considered as zones of interest, on the point cloud and to select certain of these zones as flat zones according to a quality criterion corresponding to the thickness of these zones.

More precisely, the known method consists in performing an initial approximate reconstruction of a point cloud from an a priori device trajectory. Approximately flat areas on the point cloud are identified. Their thickness is evaluated to determine whether it corresponds to a predefined thickness. This involves comparing the thickness of the point cloud along a zone with the predefined thickness. If the thickness of the point cloud along a zone corresponds to the predefined thickness, these zones are selected as flat zones, then the global trajectory of the device is modified to reduce the thickness of the approximately flat zones found, i.e. to make them effectively flat.

However, this solution is not satisfactory. The thickness criterion is subjective and imprecise. For example, if too great a predefined thickness is tolerated, there is a risk of selecting areas that are not actually flat.

On the other hand, if too low a predefined thickness is tolerated, there is a risk of finding very few flat areas. This risk arises from the fact that, for a predefined thickness that is too low, the trajectory of the measuring device must be known with all the more precision. This is because approximately flat areas only appear truly flat once the trajectory of the measuring device is known. However, when the approximately flat area is compared with the predefined thickness, the only map of the environment available is an approximate reconstruction of the environment based on an approximate trajectory of the measuring device. Thus, if the predefined thickness is too fine, there is a risk that effectively flat areas will not meet this criterion on the approximate map. What's more, if such areas do meet the thickness criterion, they are already very thin. This means that they cannot be used for subsequent correction of the measuring device's trajectory.

The invention aims to at least partially solve the technical problems outlined.

### SUMMARY OF THE INVENTION

Thus, the invention relates to a system for constructing a map of an environment, the system comprising:
a measuring device comprising at least one lidar configured to acquire a point cloud representative of said environment in which the measuring device moves around,
a processor configured to
   pre-select a plurality of initial point sets from the point cloud, each initial point set of the plurality of initial point sets being representative of a potential area of interest in the environment,
   for each initial point set, search for a local correction to be made to a movement of the measuring device along each potential zone of interest represented by the initial point set under consideration, in order to determine whether each initial point set actually represents a zone of interest,
   jointly correct the initial point sets representing a zone of interest, by applying a global correction to a movement of the measuring device in the environment,
   build the map of the environment with the corrected initial point sets effectively representing an area of interest and the initial point sets not representing an area of interest.

The invention also relates to a method of constructing a map of an environment, comprising:
The acquisition, by a measuring device comprising at least one lidar, of a point cloud representative of said environment in which the measuring device is moving,
Implementing, by a processor:
   a preselection of a plurality of initial point sets from the point cloud, each initial point set of the plurality of initial point sets being representative of a potential area of interest in the environment,
   for each initial point set, a search for a local correction to be made to a movement of the measuring device along each potential zone of interest represented by the initial point set under consideration, in order to determine whether each initial point set actually represents a zone of interest,
   a joint correction of the initial point sets actually representing an area of interest, by applying a global correction to a movement of the measuring device in the environment,
   a construction of the environment map with the corrected initial point sets effectively representing an area of interest and the initial point sets not representing an area of interest.

In this way, contrary to the prior art, areas of interest are not identified by looking at the roughly constructed map to identify areas that would resemble a plane, but by performing local trajectory corrections on sets of points, the aim of these corrections being to transform certain areas into areas of interest, and thus determine whether a set of points actually represents an area of interest or not. Advantageously, all points in the point cloud belong to an initial point set. In this way, the system can effectively determine which potential area of interest is actually an area of interest: indeed, if a local correction of the trajectory along a potential area of interest actually reveals an area of interest, this means that the potential area of interest is actually an area of interest. Global trajectory correction can then be based on the zone of interest actually determined.

In particular, when the processor seeks to correct the trajectory locally, the local correction may reveal an area of interest, or the local correction applied may reveal that the set of points under consideration is not an area of interest. For example, if the area of interest sought is a flat area, local correction of the trajectory along the set of points under consideration will reveal the flat area. On the other hand, if the set of points considered is not a flat area, no local correction will reveal a flat area.

According to various aspects, it is possible to provide one and/or other of the following features taken alone or in combination.

In one embodiment, the processor is configured to iterate the preselection, local correction and joint correction steps until a predefined criterion is met.

This arrangement makes it possible to obtain a more accurate local trajectory correction, and/or to determine with greater certainty whether an area of interest is indeed an area of interest or not.

In one embodiment, local correction searches for each initial set of points are carried out in parallel.

In this way, areas of interest are identified more quickly than if the processor were to search for local corrections in series. The result is a system that responds to the SLAM problem in real time, instantaneously or almost instantaneously.

According to one embodiment, the local correction to be made to a movement of the device comprises the correction of a local trajectory of the device along each potential area of interest and wherein the joint correction comprises the correction of a global trajectory of the measuring device in the environment.

According to one embodiment, the local correction to be made to a movement of the device comprises the correction of a local velocity of the device along each potential zone of interest and wherein the joint correction comprises the correction of a global trajectory of the measuring device in the environment.

The correction can therefore be made on the trajectory or on the speed. The two corrections can be performed in parallel or interchangeably.

In one embodiment, the global correction to be made to a movement of the measuring device in the environment is determined by solving an optimization problem.

According to one embodiment, the areas of interest comprise a flat area such as a road, a road sign or a wall, the processor being configured, for each potential area of interest corresponding to a potential flat area, to calculate a minimum thickness C′ of said potential flat area obtained after local correction of the motion of the measuring device, said minimum thickness being obtained by direct resolution of:

$${C}^{′} ( X , T ) = Λ ( \frac{1}{N - 1} [ {\sum }_{i} ( {x}_{i} - \overline{x} ) {( {x}_{i} - \overline{x} )}^{T} ] - \frac{1}{N - 1} {SS}^{T} )$$

where N is the number of pointsxᵢ in the initial set of points considered,

$$\overline{x} = \frac{1}{N} {\sum }_{i} {x}_{i}$$

is the average of the pointsxᵢ in the initial set of points,

$$\overline{t} = \frac{1}{N} {\sum }_{i} {x}_{i}$$

is the average of the instantstᵢ associated with said points in the initial point set,

$$s = \frac{{\sum }_{i} ( {t}_{i} - \overline{t} ) {x}_{i}}{\sqrt{{\sum }_{i} {( {t}_{i} - \overline{t} )}^{2}}}$$

is a calculation intermediate,

$$\frac{1}{N - 1} {\sum }_{i} ( {x}_{i} - \overline{x} ) {( {x}_{i} - \overline{x} )}^{T}$$

is the covariance matrix, and the function∧(·) returns the smallest eigenvalue of the matrix given as an argument, and wherein the processor is configured to determine that the potential flat area is indeed an area of interest if C′ is below a predefined threshold.

In this way, the criterion for determining that a zone is indeed an area of interest can be calculated directly. No intermediate optimization step is required. This advantage is specific to the case where the correction is applied to speed and when the zone of interest is a flat area.

According to one embodiment, the zones of interest comprise a cylindrical zone such as a pole, the processor being configured, for each potential zone of interest corresponding to a potential cylindrical zone, to determine a correction of a local movement (Δmouv) of the measuring device for which the distance is minimum between each of the N pointsxᵢ of the initial set of points considered and a cylinder of center c, axis u and radius r according to a double minimization:

$${min}_{Δ mouv} {min}_{u , c , r} \frac{1}{N} {\sum }_{i} {\vert \sqrt{{‖ {x}_{i} ( Δ mouv ) - c ‖}^{2} - {‖ {u}^{T} ( {x}_{i} ( Δ mouv ) - c ) ‖}^{2}} - r \vert}^{2} ,$$

where Δmouv is a variation in the movement of the measuring device 10 at each point xᵢ, and where x_{i=1, 2, . . .} (Δmouv) is the position of point i after application of a variation in movement Δmouv, the processor being further configured to determine that a potential cylindrical area of interest is indeed a cylindrical area of interest if a result of the double minimization is below a predefined threshold.

In this way, the processor is configured to locate areas of interest corresponding to cylindrical zones.

According to one embodiment, for each initial set of points effectively representing an area of interest, the processor is configured to remove points present in the initial set of points but not belonging to said area of interest.

This avoids distorting the global trajectory correction by considering points that are not part of an area of interest.

### BRIEF DESCRIPTION OF THE DRAWINGS

Further embodiments of the invention will be described below with reference to the drawings, described briefly below:

FIG. 1 shows a mapping system in one embodiment.

FIG. 2 illustrates steps in a process for constructing a map of an environment using the system according to one embodiment.

FIG. 3 illustrates steps in a process for constructing a map of an environment using the system according to another embodiment.

In the drawings, identical references designate identical or similar objects.

### DETAILED DESCRIPTION

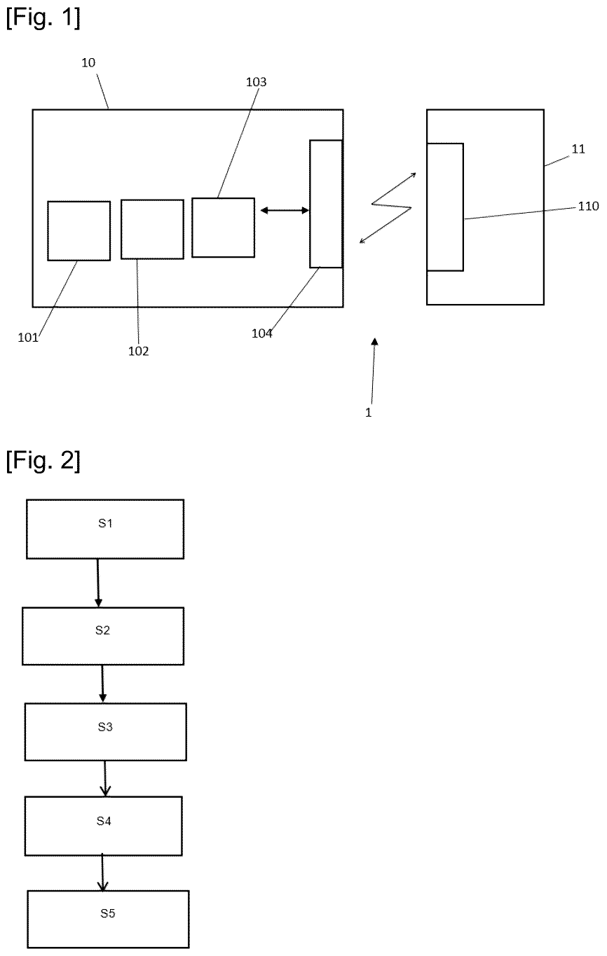

The invention relates to a mapping system shown in FIG. 1. The system 1, comprises a measuring device 10 including at least one lidar 101. The measuring device may also comprise an inertial measurement unit (IMU) 102 and a camera 103. The IMU may comprise at least one accelerometer and at least one gyroscope.

The measuring device can be mounted on a movable object (not shown). The object may be a drone, a backpack carried by a moving person, a car, a robot, or any other mobile object. The mobile object comprising the measuring device 10 moves in an environment to be mapped. Such an environment may be indoors, for example inside a building, or outdoors, for example outside a building, on a street, on a road, on a construction site, and so on.

As the object moves, the lidar is configured to take measurements. These measurements include the acquisition of point clouds representative of the environment. From at least the point cloud, a map of the environment can be constructed.

System 1 also includes a processor 11. Processor 11 can be connected to the measurement device, so as to receive the data measured by the lidar, camera and/or IMU. In one configuration, communication between processor 11 and measuring device 10 can be wired. In another configuration, communication between processor 11 and measuring device 10 can be remote, for example via radio waves, Bluetooth or wifi.

In one configuration, the measuring device 10 and processor 11 exchange data via a respective communication interface 104 and 110.

In one configuration, the processor 11 can be embedded in the measuring device 10. In another configuration, processor 11 can be hosted on a remote server. In this configuration, communication is therefore remote, for example by radio waves, via the 4G and/or 5G network, Bluetooth or wifi.

System 1 may also include graphics cards and one or more large-capacity hard disks, in the terabyte range.

FIG. 2 illustrates the steps in a process for constructing a map of an environment using system 1.

In step S1, the measuring device 10 acquires data.

More specifically, lidar 101 acquires at least one point cloud representative of the environment. In a preferred configuration, the measuring device 10 moves at each instant and the lidar acquires a point cloud at each instant. In this way, a plurality of point clouds are acquired as the measuring device 10 moves through the environment.

The IMU can also acquire data, such as the orientation and acceleration of the measuring device 10 as it moves through the environment.

The data acquired by the lidar and/or IMU are used to construct the environment map. In particular, the map of the environment can be constructed after the measuring device has passed through the environment for the first and only time. The point clouds acquired by the lidar and the orientation and acceleration data of the measuring device 10 acquired by the IMU on a passage of the measuring device 10 in the environment are used to construct the environment map. More specifically, the IMU's acceleration measurement, called specific force, is defined as the difference between acceleration and gravity. This measure provides indirect information on the device's acceleration.

In another embodiment, the environment map can be constructed after several passes of the measuring device through the environment. The point clouds acquired by the lidar and the orientation and acceleration data of the measuring device 10 acquired by the IMU over the passes of the measuring device 10 in the environment are used to construct the environment map.

However, in order to construct a map of satisfactory quality, i.e. one that is clear and not blurred, it is necessary to know the trajectory of the measuring device 10 as it passes through the environment. Indeed, when the trajectory of the measuring device is not precisely known, the map of the environment appears blurred.

The search for the trajectory of the measuring device and the construction of the map from the data acquired by lidar 102 and IMU 103 are carried out simultaneously, and advantageously at the same time and in real time.

In order to search for the trajectory of measuring device 10, it may be advantageous to define areas of interest along which trajectory search can be facilitated. These zones of interest may be, for example, a flat area such as a wall, roadside, sidewalk, etc., or objects such as traffic signs and their supports, or wall corners.

More specifically, each point in the point clouds acquired by lidar 101 is described by three coordinates describing a position in the orthogonal reference frame attached to the measuring device, as well as a measurement instant t. The points are also described by an intensity representing the fraction of laser light energy emitted by lidar 101 and reflected by the affected material. Zones of interest can therefore be determined on the basis of the distribution of points in space (for flat zones, for example) or on the basis of intensity.

In order to identify areas of interest and construct a map correctly representing these areas of interest, the processor preselects a plurality of initial point sets from the point cloud in step S2, each initial point set of the plurality of initial point sets being representative of a potential area of interest in the environment.

The areas of interest are not known until the map is definitively constructed. As a result, it is necessary to determine which areas of the environment are actually zones of interest. In order to miss as few areas of interest as possible, which can help build an accurate map of the environment, the initial point sets pre-selected by the processor can cover all the points in the point cloud. More precisely, each point in the point cloud is integrated into at least one initial point set. In other words, all areas of the environment can be preselected by the processor in step S2, in order to study them and determine whether they indeed represent an area of interest, as described in step S3.

Then, in step S3, for each initial set of points, the processor 11 searches for a local correction to be made to a movement of the measuring device 10 along each potential zone of interest represented by the initial set of points under consideration, in order to determine whether each initial set of points actually represents a zone of interest.

For example, areas of interest representing a flat area of the environment only appear flat, i.e. with a small thickness in the environment map, once the true trajectory of the measuring device 10 along this flat area has been determined.

For areas of interest representing a road sign, or a wall corner, for example, they only appear sharp once the true trajectory of the measuring device 10 along this area of interest has been determined.

In the case of zones of interest representing a flat area, in order to determine whether potential zones of interest are indeed flat areas, processor 11 will locally correct a motion of the measuring device corresponding to a velocity of measuring device 10 along each potential zone of interest. The local speed correction is independent for each potential zone of interest, so that processor 11 can search for each local correction in parallel. This greatly reduces computation time, so that the trajectory of measuring device 10 can be searched in real time.

Mathematically, the search for the local correction to be made to the movement of the measuring device 10 along each potential zone of interest comprises the definition of a criterion C′(X,T) applied to each initial point setX=(x₁, x₂, . . . ) representing the potential zone of interest and to a series of associated instantsT=(t₁, t₂, . . . ) at the points of the initial point set, and where C′ corresponds to the smallest squared thickness, i.e. the minimum squared thickness, obtained following the local correction of the movement of the measuring device 10. This minimum squared thickness must be less than a predefined threshold to determine that a potential area of interest is indeed an area of interest, i.e. a flat area, for example.

Advantageously, the predefined threshold represents an expected squared thickness, which takes into account measurement noise but not reconstruction errors. In particular, LiDAR manufacturers indicate an uncertainty in distance δr\hat{ }, azimuth δθ and elevation δe in the form of standard deviation or maximum error value. From this we can deduce a global quadratic error of measurement equal to (δr)²+(rδe)²+(r cos(e)δθ)², where r is the measured distance and e is the elevation.

The global square error of measurement provides a possible threshold value if the uncertainties, δr\hat{ }δθ^{δe} given by the manufacturer represent maximum errors. If the uncertainties, δr\hat{ }δθ^{δe} given by the manufacturer are standard deviations, they can be multiplied by three to obtain a threshold value representative of the expected squared thickness.

In another embodiment, in which the thickness, and not the squared thickness, is compared with a predefined threshold, the square root of the criterion C′ is compared with the square root of the global squared error of measurement. When the uncertainty values, δr\hat{ }δθ^{δe} given by the manufacturer are standard deviations, the uncertainty values are also multiplied by three to obtain a threshold representative of the expected thickness.

In the following description, and in a non-limiting manner, the criterion C′ corresponds to or is representative of a squared thickness and the predefined threshold is representative of the global squared measurement error.

So, in order to determine whether the potential area of interest is indeed an area of interest, an optimization problem can be solved. It takes the form:

$${C}^{′} = {min}_{Δ mouv} C ( {x}_{1} ( Δ mouv ) , {x}_{2} ( Δ mouv ) , … ) \qquad ( 1 )$$

Where Δmouv is a variation in the motion of the measuring device 10 at each point x, and where x_{i=1, 2, . . .} (Δmouv) is the position of point i after application of a motion variation Δmouv. The initial position of point xᵢ(0), for Δmouv=0, is simply denoted xᵢ. In other words, processor 11 searches for a correction of all positions equivalent to a variation in motion Δmouv of measuring device 10. The minimum value of C(x₁(Δmouv), x₂(Δmouv), . . . ) is denoted C′.

By solving the optimization problem, we obtain the value of criterion C′ and determine whether the potential area of interest is indeed an area of interest by comparing C′ with the predefined threshold.

According to a second embodiment in which only the local velocity is corrected, the optimization problem takes the form:

$${C}^{′} = {min}_{Δ v} C ( {x}_{1} ( Δ v ) , {x}_{2} ( Δ v ) , … )$$

Where Δv is a variation in the speed of the measuring device 10 at each point xᵢ, and where xᵢ(Δv) can be written xᵢ-tᵢΔv, with i=1, 2, . . . . In other words, the processor 11 searches for a correction of all positions equivalent to a speed variation Av of the measuring device 10. The minimum value of C(x₁(Δv), x₂(Δv), . . . ) is noted C′(x₁, x₂, . . . , t₁, t₂, . . . ).

Furthermore, in an embodiment in which only the local velocity is corrected and in which the criterion C corresponds to the smallest eigenvalue of the covariance matrix

$$\frac{1}{N - 1} {\sum }_{i} ( {x}_{i} - \overline{x} ) {( {x}_{i} - \overline{x} )}^{T} ,$$

the result of the optimization problem (1) can then be obtained directly:

$${C}^{′} ( X , T ) = Λ ( \frac{1}{N - 1} [ {\sum }_{i} ( {x}_{i} - \overline{x} ) {( {x}_{i} - \overline{x} )}^{T} ] - \frac{1}{N - 1} {SS}^{T} )$$

With xᵢ the three-coordinate points of the initial point set representing a potential area of interest, N the number of points in the initial point set under consideration, x̅ is the average position of said points defined by,

$$\overline{x} = \frac{1}{N} {\sum }_{i} {x}_{i} \overline{t}$$

is the average position of said instants defined by

$$\overline{t} = \frac{1}{N} {\sum }_{i} {t}_{i} ,$$

the sum

$$\frac{1}{N - 1} {\sum }_{i} ( {x}_{i} - \overline{x} ) {( {x}_{i} - \overline{x} )}^{T}$$

is the covariance matrix of the points,

$$s = \frac{{\sum }_{i} ( {t}_{i} - \overline{t} ) ( {x}_{i} - \overline{x} )}{\sqrt{{\sum }_{i} {( {t}_{i} - \overline{t} )}^{2}}}$$

and the function∧(·) returns the smallest eigenvalue of the matrix given as an argument.

According to this embodiment, once the C′ value has been determined, it is then possible to determine whether the potential area of interest is indeed an area of interest. In this example, the area of interest considered is a flat area. In fact, the covariance matrix characterizes the distribution of points in the local orthogonal reference frame locating the points of the initial set of points representing the potential area of interest. Thus, if C′ is less than the predefined threshold, the zone is determined to be flat.

If the potential zone of interest is not actually a zone of interest, i.e. if the potential zone of interest is not flat, C′ will take on a value greater than the predefined threshold, and this value will increase with the actual thickness of the point cloud formed by the set of points associated with the potential zone of interest under consideration.

Thus, according to the second embodiment, the calculation of the value of criterion C′ is direct and does not require an optimization process. This advantage is specific to cases where speed correction is required. It also greatly reduces calculation times and memory requirements.

Furthermore, since the predefined threshold represents an expected quadratic thickness affected by measurement noise but not by reconstruction errors, it is accurately determined whether a potential area of interest is indeed an area of interest.

The search for zones of interest representing flat areas in the environment was described above. As mentioned above, these areas can include a wall, a wall corner, a roadside, a sidewalk, but also a flat signpost.

Typically, such signs are supported by cylindrical posts. In such cases, it may be useful to define the sign and post assembly, or simply the post, as an area of interest.

With regard to flat areas, one criterion for indicating that an area is flat is to determine that all points in the area belong to the same plane, as described above. It is possible to define such a criterion for more complex shapes such as cylinders.

The aim is to determine whether a cylinder can pass through all the points in the initial set of points corresponding to the cylindrical-shaped element. Such an element may be a post, but also a tree trunk, a stake, etc.

In other words, a cylinder is defined by its axis u, center c and radius r. It can be determined that a cylinder passes through all the points of an initial set of points, or passes at least close to a majority of the points if the distance between each of these points, or the vast majority of points, and this cylinder is small, or even zero.

The distance from a point xᵢ to such a cylinder is |\sqrt{∥xᵢ−c∥²−∥u^{T}(xᵢ−c)∥²}−r|. It is possible to determine that a cylinder passes through or close to all or most of the points, if the mean squared distances are below a predefined threshold corresponding to the mean square error of the Lidar distance measurements, usually provided by the lidar manufacturer. This error is generally of the order of 1 cm, but can vary depending on the lidar used.

According to this embodiment, to determine whether the cylinder parameters u, r, c correspond to the points x₁, . . . . xₙ, the root-mean-square distance of the points x₁, . . . . xₙ to the cylinder, representative of a thickness, is calculated according to:

$$\frac{1}{N} {\sum }_{i} {\vert \sqrt{{\vert \vert {x}_{i} - c \vert \vert}^{2} - {\vert \vert {u}^{T} ( {x}_{i} - c ) \vert \vert}^{2}} - r \vert}^{2}$$

However, only the xᵢ points in the potential area of interest are known. The parameters u, c and r of the cylinder that the pointsxᵢ could form are not known. The way to determine whether a cylinder passes through allxᵢ points, or at least the majority of points, is to say that there is at least one cylinder for which C will be minimal, or even equal to zero, where C is written:

$$C ( {x}_{1} , … , {x}_{N} ) = {min}_{u , c , r} \frac{1}{N} {\sum }_{i} {\vert \sqrt{{\vert \vert {x}_{i} - c \vert \vert}^{2} - {\vert \vert {u}^{T} ( {x}_{i} - c ) \vert \vert}^{2}} - r \vert}^{2}$$

Finally, the minimum value of C by applying the motion correction Δmouv, noted C′, is the criterion for determining whether the potential zone of interest is indeed a zone of interest. C′ is obtained according to:

$${C}^{′} ( {x}_{1} , … , {x}_{N} ) = {min}_{Δ mouv} {min}_{u , c , r} \frac{1}{N} {\sum }_{i} {\vert \sqrt{{\vert \vert {x}_{i} ( Δ mouv ) - c \vert \vert}^{2} - {\vert \vert {u}^{T} ( {x}_{i} ( Δ mouv ) - c ) \vert \vert}^{2}} - r \vert}^{2}$$

Where Δmouv is a correction for the motion of the measuring device along the potential zone of interest, i.e. its trajectory and/or velocity.

If the result of the double minimization is below a predefined threshold, such as the mean square error of the Lidar distance measurements, then the potential area of interest is determined to be indeed an area of interest, in this case a cylindrical shape.

If the result of the double minimization is greater than a predefined threshold, such as a multiple of root mean square error of the Lidar distance measurements, then it is determined that the potential area of interest represented by the initial set of points under consideration is not an area of interest.

It should be noted that, in cases where a correction of the local velocity of the measuring device has been described, a correction of the local trajectory of the measuring device can be made alternatively and/or additionally. In cases where a correction of the local trajectory of the measuring device has been described, a correction of the local speed of the measuring device can be made alternatively and/or additionally.

In a final embodiment, the criterion for determining whether a potential area of interest is actually an area of interest is the intensity distribution of the points in an initial set of points. Hereintensity represents the fraction of laser light energy emitted by lidar 101 and reflected by the affected material.

Such an area of interest can be an inscription, e.g. on a wall, a vehicle, etc., or an image represented on a panel, e.g. an advertising panel or a traffic sign.

In this embodiment, a local trajectory of the measuring device 10 along the potential area of interest is corrected for each initial set of points representing a potential area of interest. The aim is to determine whether, for a potential zone of interest, variations in the arrangement of intensity-bearing points are correlated with variations in the position of the measuring device. In other words, it is a question of determining whether a local variation in the trajectory of the measuring device along the potential zone of interest comprising points carrying different intensities results in a different distribution of points making it possible to define that a potential zone of interest is indeed a zone of interest. In particular, such a difference in the distribution of points bearing intensity can make it possible to render legible an inscription that would not be legible without local correction of the measuring device along this zone.

Such a criterion E can be written as:

$$E = \frac{{\vert \vert {\sum }_{i} ( {I}_{i} - \overline{I} ) ( {x}_{i} - \overline{x} ) ‖}^{2}}{{{\sum }_{i} {( {I}_{i} - \overline{I} )}^{2} {\sum }_{i} \vert \vert {x}_{i} - \overline{x} ‖}^{2}}$$

Where Iᵢ is the intensity measured at a pointxᵢ of the initial set of points,

$$\overline{I} = \frac{1}{N} {\sum }_{i} {I}_{i}$$

is the average intensity in the area and||.|| is the classical Euclidean norm of a vector, here of size 3.

A potential area of interest is deemed to be an area of interest when the value of criterion E reaches, for example, 0.5.

More precisely, for all the embodiments described with reference to step S3, calculating the value of the criterion involves making corrections to the local movement of the measuring device 10, in this case to the speed or trajectory of the measuring device 10. Calculating the criterion makes it possible to determine with certainty whether a zone of interest can actually be obtained by locally modifying the movement of the measuring device 10 along the potential zone of interest.

By the end of stage S3, all areas of interest have been identified.

Then, an optional step S4 can be implemented, in which, following the determination that a potential area of interest is indeed an area of interest, it is determined whether all the points in the initial set of points representing the area of interest actually belong to the area of interest. Indeed, in some cases, points far from the zone of interest may have been included in the zone of interest by mistake. In this case, we need to find these points and remove them.

To do this, it is possible to calculate the proximity of each point in the initial set of points to the area of interest, and then remove points that are too far from the area of interest.

More specifically, considering areas of interest such as wall corners, road signs and/or posts and flat areas.

In particular, for road signs, flat areas and wall corners, the aim is to determine whether all the points in the initial set of points form part of the same plane determined in step S3. Points that are not part of the plane formed by the area of interest are deleted.

Similarly, for more complex areas of interest, such as traffic posts, the aim is to determine whether all the points in the initial set of points form part of the cylinder determined in step S3. Points not forming part of the cylinder formed by the area of interest are removed.

In step S5, a joint correction is applied to the initial point sets effectively representing an area of interest by applying a global correction to a movement of the measuring device 10 in the environment. More specifically, the global correction is applied to a trajectory of the measuring device 10 in the environment.

This global, rather than local, correction of the trajectory of the measuring device 10 is due to the fact that the aim is to find a single trajectory to obtain a map of the environment on which all the identified zones of interest are represented, and not to find different trajectories for each zone of interest.

This is solved by means of an optimization problem. The trajectory is obtained by defining an optimization problem comprising two components: the criterion for the structure of the zones of interest (flatness, for example) and the correspondence between the chosen trajectory and the additional measurements available, from an inertial measurement system, for example. Solving such an optimization problem is well understood, and off-the-shelf solvers offer it in a fairly generic framework, such as the GTSAM solver mentioned in the following publication:

Kaess, M., Johannsson, H., Roberts, R., IIa, V., Leonard, J. J., & Dellaert, F. (2012). iSAM2: Incremental smoothing and mapping using the Bayes tree. The International Journal of Robotics Research, 31(2), 216-235.

Then, once the global trajectory of the measuring device has been corrected, the environment map is constructed with the corrected initial point sets that do represent an area of interest, and with the initial point sets that do not represent an area of interest.

In one embodiment, the map of the environment and the correction of the global trajectory of the measuring device 10 are carried out simultaneously.

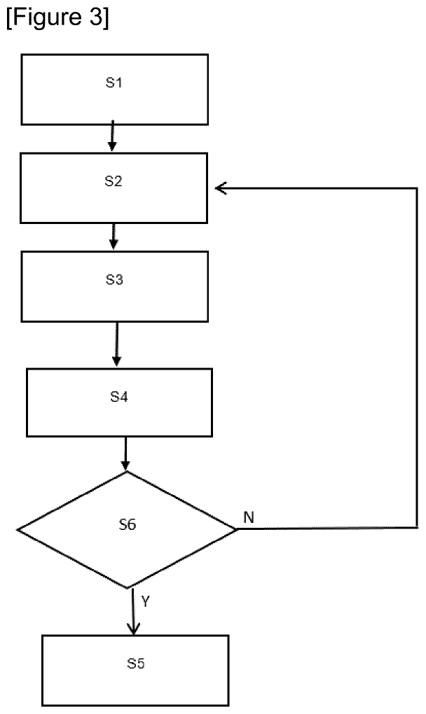

FIG. 3 illustrates a further embodiment of the invention. Steps S1 to S5 described in relation to FIG. 2 are identical. According to this embodiment, steps S2 to S4 are iterated until a predefined criterion is met in step S6.

This predefined criterion can be reached when the motion correction of the measuring device no longer changes between two iterations.

This arrangement makes it possible to obtain a more accurate local trajectory correction, and/or to determine with greater certainty whether an area of interest is indeed an area of interest or not.

1. A system for constructing a map of an environment, the system comprising:
a measuring device comprising at least one lidar configured to acquire a point cloud representative of said environment in which the measuring device moves around,
a processor configured to implement the following steps:
pre-select a plurality of initial point sets from the point cloud, each initial point set of the plurality of initial point sets being representative of a potential area of interest in the environment,
for each initial point set, search for a local correction to be made to a movement of the measuring device along each potential zone of interest represented by the initial point set under consideration, in order to determine whether each initial point set actually represents a zone of interest,
jointly correct the initial point sets representing a zone of interest, by applying a global correction to a movement of the measuring device in the environment,
build the map of the environment with the corrected initial point sets effectively representing an area of interest and the initial point sets not representing an area of interest.

2. The system according to claim 1, in which the processor is configured to iterate the pre-selection, local correction and joint correction steps until a predefined criterion is met.

3. The system according to claim 1, in which the processor is configured to perform local correction searches for each set of initial point set in parallel.

4. The system according to claim 1, wherein the local correction to be made to a movement of the measuring device comprises the correction of a local trajectory of the measuring device along each potential zone of interest and wherein the joint correction comprises the correction of a global trajectory of the measuring device in the environment.

5. The system according to claim 1, wherein the local correction to be made to a movement of the measuring device comprises the correction of a local velocity of the measuring device along each potential zone of interest and wherein the joint correction comprises the correction of an global trajectory of the measuring device in the environment.

6. The system according to claim 1, in which the global correction to be made to a movement of the measuring device in the environment is determined by solving an optimization problem.

7. The system according claim 5, in which the areas of interest comprise a flat area such as a road, a road sign or a wall, the processor being configured, for each potential area of interest corresponding to a potential flat area, to calculate a minimum thickness C′ of said potential flat area obtained after local correction of the motion of the measuring device, said minimum thickness being obtained by direct resolution of
$${C}^{′} ( X , T ) = Λ ( \frac{1}{N - 1} [ {\sum }_{i} ( {x}_{i} - \overline{x} ) {( {x}_{i} - \overline{x} )}^{T} ] - \frac{1}{N - 1} {ss}^{T} )$$
where N is the number of pointsx; in the initial set of points considered,
$$\overline{x} = \frac{1}{N} {\sum }_{i} {x}_{i}$$
is the average of the pointsxᵢ in the initial set of points,
$$\overline{t} = \frac{1}{N} {\sum }_{i} {t}_{i}$$
is the average of the instantstᵢ associated with said points in the initial set of points,
$$s = \frac{{\sum }_{i} ( {t}_{i} - \overline{t} ) {x}_{i}}{\sqrt{{\sum }_{i} {( {t}_{i} - \overline{t} )}^{2}}}$$
is the calculation intermediate,
$$\frac{1}{N - 1} {\sum }_{i} ( {x}_{i} - \overline{x} ) {( {x}_{i} - \overline{x} )}^{T}$$
the function∧(·) returns the smallest eigenvalue of the matrix given as argument, and where the processor is configured to determine that the potential flat area is indeed an area of interest if C′ is below a predefined threshold.

8. The system according to claim 1, in which the zones of interest comprise a cylindrical zone such as a post, the processor being configured, for each potential zone of interest corresponding to a potential cylindrical zone, to determine whether there exists a correction of a local movement (Δmouv) of the measuring device for which the distance is minimal between each of the N points xi of the initial set of points considered and a cylinder of center c, axis u and radius r according to a double minimization:
$${min}_{Δ mouv} {min}_{u , c , r} \frac{1}{N} {\sum }_{i} {\vert \sqrt{{\vert \vert {x}_{i} ( Δ mouv ) - c \vert \vert}^{2} - {\vert \vert {u}^{T} ( {x}_{i} ( Δ mouv ) - c ) \vert \vert}^{2}} - r \vert}^{2} ,$$
where Δmouv is a variation in the movement of the measuring device 10 at each point xᵢ, and where x_{i=1, 2, . . .} (Δmouv) is the position of point i after application of a variation in movement Amouv, the processor being further configured to determine that a potential cylindrical area of interest is indeed a cylindrical area of interest if a result of the double minimization is below a predefined threshold.

9. The system according to claim 1, in which for each initial set of points effectively representing an area of interest, the processor is configured to remove points present in the initial set of points but not belonging to said area of interest.

10. A method of constructing a map of an environment, the method comprising:
The acquisition, by a measuring device (comprising at least one lidar, of a point cloud representative of said environment in which the measuring device moves,
Implementing, by a processor:
a preselection of a plurality of initial point sets in the point cloud, each initial point set of the plurality of initial point sets being representative of a potential area of interest in the environment,
for each initial point set, a search for a local correction to be made to a movement of the measuring device along each potential zone of interest represented by the initial point set under consideration, in order to determine whether each initial point set actually represents a zone of interest,
a joint correction of the initial point sets actually representing an area of interest, by applying a global correction to a movement of the measuring device in the environment,
a construction of the environment map with the corrected initial point sets effectively representing an area of interest and the initial point sets not representing an area of interest.
